(19) United States
(12) Patent Application Publication
(10) Pub. No.: US 2003/0202671 A1
(43) Pub. Date: Oct. 30, 2003

(54) Product configuration with a double-side adhesive mounting disc

(75) Inventor: Thomas Pauser, Vienna (AT)

Correspondence Address: Corporate Patent Counsel, U.S. Philips Corporation, 580 White Plains Road, Tarrytown, NY, 10591, US

(73) Assignee: KONINKLIJKE PHILIPS ELECTRONICS N.V.

(21) Appl. No.: 10/422,520

(22) Filed: Apr. 24, 2003

(30) Foreign Application Priority Data
Apr. 30, 2002 (EP) 02 100 433.8

(51) Int. Cl. H04R 25/00

(52) U.S. Cl. 381/150; 381/385

(57) ABSTRACT

In a product configuration (1) comprising a product (2) and a mounting disc (4) connected to the product (2), wherein the mounting disc (4) is provided with an adhesive layer (8), said adhesive layer (8) is covered with a protective foil (9) which is connected to a protective foil removal strip (10) that can be brought into contact with a protective holder (15) during insertion of the product configuration (1) into said protective holder (15) for the product configuration (1), such that a subsequent removal of the product configuration (1) from the protective holder (15) ensures an automatic removal of the protective foil (9) from the second adhesive layer (8) by the protective holder (15).

The invention relates to a product configuration consisting of a product and a fastening means connected to the product for fastening the product to a product carrier, which fastening means comprises an adhesive layer provided for being connected to the product carrier.

The invention further relates to a protective holder for a product configuration in accordance with the construction described in the first paragraph.

A product configuration of the construction described in the first paragraph is known, for example, from the patent document U.S. Pat. No. 5,974,655 A. In this patent document, the product configuration is shown in two positions, i.e. in a position immediately before fastening of the product configuration to a product carrier, a printed circuit board in this case, and in a further position in which the product configuration is connected to the product carrier. In the position obtaining immediately before fastening of the product configuration to the product carrier, the adhesive layer provided for connection to the product carrier is exposed so that it can be adhered to the product carrier subsequently.

It is known in such a product configuration to cover the adhesive layer provided for connection to the product carrier with a protective foil that can be removed from this adhesive layer, so as to protect said adhesive layer against pollution and other unfavorable influences. This protective foil should obviously be removed from the adhesive layer provided for connection to the product carrier before the product configuration is fastened to the product carrier. This takes place in the prior art arrangements in that the protective foil is pulled off the adhesive layer provided for connection to the product carrier either by means of a separate pulling device or by hand in a removal step that is to be separately carried out. This, however, represents a considerable expenditure which makes the manufacture of the product configuration longer and more expensive. Furthermore, a manual removal of the protective foil involves the risk of a partial damage of the adhesive layer provided for connection to the product carrier, as a result of which the reliability of the adhesive joint created by means of this adhesive layer may suffer.

The invention has for its object to eliminate the problems described above and to realize an improved product configuration and an improved protective holder for a product configuration.

To achieve the above objects, inventive features are provided in a product configuration according to the invention such that a product configuration according to the invention can be characterized as indicated below.

A product configuration consisting of a product and a fastening means connected to the product for fastening the product to a product carrier, wherein the fastening means comprises an adhesive layer provided for connection to the product carrier, and wherein the adhesive layer is covered by a protective foil that can be removed from the adhesive layer, and wherein the protective foil is provided with a protective foil removal means, and wherein the protective foil removal means is designed for being mechanically connected to a protective holder for the product configuration such that upon a removal of the product configuration from the protective holder an automatic removal of the protective foil from the adhesive layer by the protective holder is ensured.

To achieve the objects defined above, inventive features are provided in a protective holder according to the invention such that a protective holder according to the invention can be characterized as follows.

A protective holder for a product configuration whose characteristics are defined above and whose characteristics are defined in claim 1, wherein the protective holder comprises a component for making mechanical contact with the protective foil removal means of the protective foil of the product configuration.

The provision of the features according to the invention achieves in a very simple and space-saving manner and with only a very small additional expenditure that the removal of the protective foil from the adhesive layer provided for connection to the product carrier does not require a separate process step, but instead is carried out automatically by the protective holder, i.e. at the moment when the product configuration, which after its manufacture was inserted into a protective holder so as to be transported to that location where the product configuration is to be connected to a product carrier, is taken from the protective holder. This is advantageously carried out by an automatic mounting machine, which has the additional advantage that damage to the adhesive layer provided for connection to the product carrier is excluded with a high degree of certainty.

The construction of a product configuration according to the invention may be such that the protective foil is connected to a further adhesive layer at its side facing away from the adhesive layer provided for connection to the product carrier, by means of which further adhesive layer the protective foil can be adhered to a component of a protective holder. It was found to be highly advantageous, however, when a lateral, strip-shaped extension is connected to the protective foil, which extension forms the protective foil removal means and whose free end is designed for making contact with a component of a protective holder. This is advantageous for achieving as inexpensive as possible an implementation and for obtaining the highest possible degree of freedom as regards the direction of removal of the product configuration from the protective holder.

In a product configuration as mentioned above, the free end of the strip-shaped extension may be connected to a component of a protective holder by means of a dot-shaped adhesive joint. It was found to be particularly advantageous, however, when the strip-shaped extension in such a product configuration has at least one projection extending transversely to the longitudinal strip direction away from the strip-shaped extension in the region of its free end, which projection is provided and shaped so as to grip behind a component of a protective holder. A particularly simple and inexpensive construction is achieved thereby.

In relation to an embodiment as described above with a strip-shaped extension with at least one transversely extending projection, it was found to be very advantageous for a protective holder if said protective holder has a partition wall in which a passage is provided, through which passage the strip-shaped extension of the protective foil of the product configuration is to be passed, and which extension wall is provided for being mechanically connected to the strip-shaped extension in that at least one projection of the strip-shaped extension grips behind this partition wall.

The above and further aspects of the invention will become apparent from the embodiments described below and are clarified with reference to these embodiments.

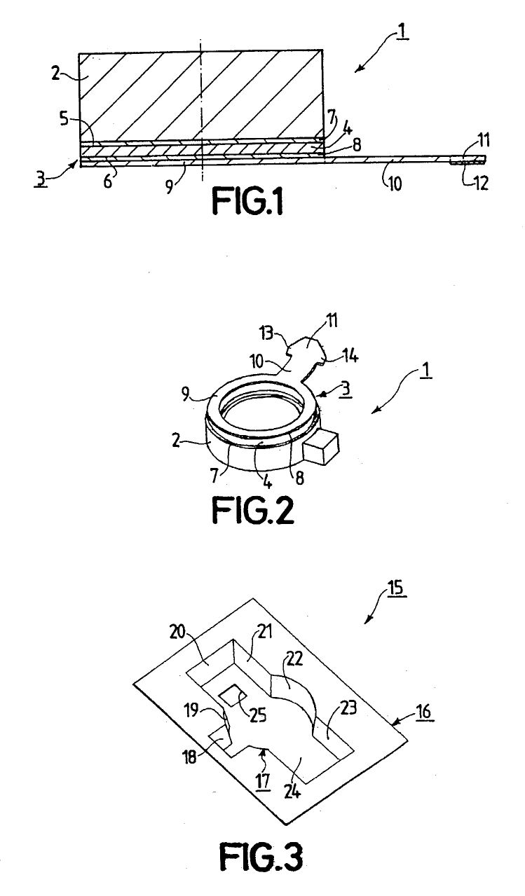

FIG. 1 shows a product configuration in a first embodiment of the invention in a highly diagrammatic cross-sectional view.

FIG. 2 shows a product configuration in a second embodiment of the invention viewed obliquely from below.

FIG. 3 shows a portion of a protective holder for a product configuration of FIG. 2 in an oblique view from above.

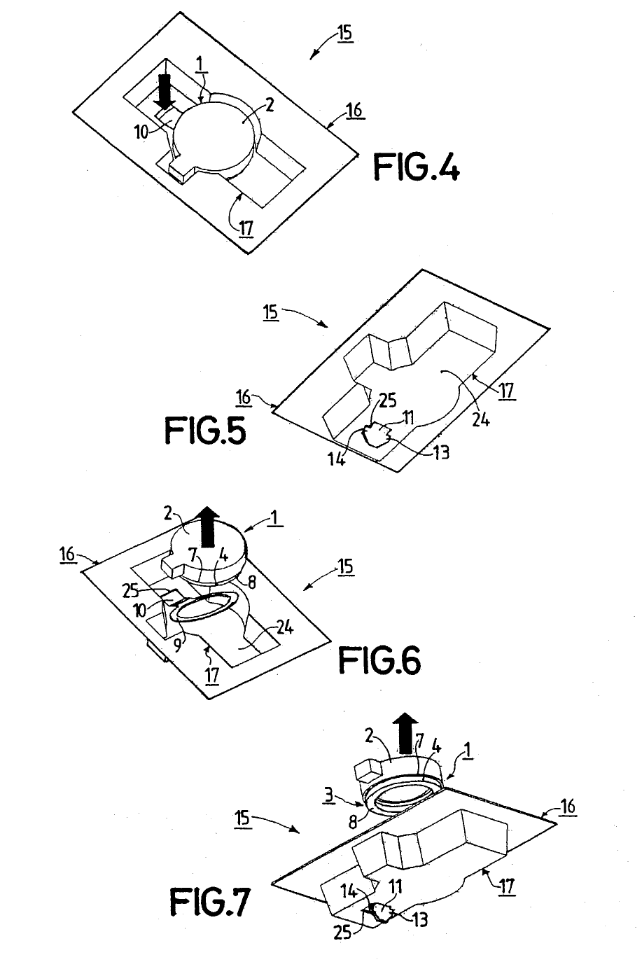

FIG. 4 shows the portion of the protective holder of FIG. 3 with the product configuration of FIG. 2 inserted therein in an oblique view from above.

FIG. 5 shows the portion of the protective holder of FIGS. 3 and 4 with the product configuration of FIG. 2 inserted therein in an oblique view from below.

FIG. 6 shows the portion of the protective holder of FIGS. 3, 4, and 5 with the product configuration of FIG. 2 already taken from the protective holder in an oblique view from above.

FIG. 7 shows the portion of the protective holder of FIGS. 3, 4, 5, and 6 with the product configuration of FIG. 2 already taken from the protective holder in an oblique view from below.

FIG. 1 shows a product configuration 1 which is formed by a product 2 and a fastening means 3 connected to the product 2 for fastening the product 2 to a product carrier not shown in FIG. 1. The product carrier in the present case is formed by a printed circuit board as is known per se from the cited patent document U.S. Pat. No. 5,974,655 A. The product carrier may alternatively be formed by a housing of an appliance, for example by the housing of a manually operable dictation device, or by the housing of a mobile telephone. The product 2 in the present case is an electroacoustic transducer, i.e. a microphone. The product 2 may alternatively be a display device for an appliance, for example a so-called LCD. Other products, such as an LED holder with an LED, may also form part of such a product configuration 1.

The fastening means 3 comprises a mounting disc 4. The mounting disc 4 is made of a foam material in the present case and serves not for fastening but for compensating for height tolerances and for damping mechanical vibrations. The mounting disc 4 comprises a first main surface 5 and a second main surface 6 extending parallel to the first main surface 5. A first adhesive layer 7 is provided in the region of the first main surface 5. A second adhesive layer 8 is provided in the region of the second main surface 6. The fastening means 3 is joined to the product 2 by the first adhesive layer 7. The second adhesive layer 8 is provided for fastening the product 2 to the product carrier (not shown).

The second adhesive layer 8 is covered with a protective foil 9, which can be removed from the second adhesive layer 8, in the non-assembled state of the product configuration 1 as shown in FIG. 1. The protective foil 9 serves to protect the second adhesive layer 8 as long as the product configuration 1 is not yet joined to the product carrier (not shown). The protective foil 9 is provided with a protective foil removal means 10, i.e. a lateral strip-shaped extension 10 is connected to the protective foil 9 so as to form the protective foil removal means 10.

The strip-shaped extension 10 serving as the protective foil removal means 10 is constructed for making mechanical contact with a protective holder (not shown in FIG. 1) for the product configuration 1 such that a removal of the product configuration 1 from the protective holder (not shown) ensures an automatic removal of the protective foil 9 from the second adhesive layer 8 by the protective holder (not shown). The construction is such in the present case that a self-adhesive layer 12 is provided in the region of the free end 11 of the strip-shaped extension 10, by means of which layer 12 an adhesive joint can be achieved with a partition wall of said protective holder upon insertion of the product configuration 1 into the protective holder (not shown), i.e. such that a subsequent removal of the product configuration 1 from the protective holder (not shown) causes the protective foil 9 to be retained in this protective holder by means of the adhesive joint achieved by the self-adhesive layer 12, whereby the protective foil 9 is automatically detached from the second adhesive layer 8.

FIG. 2 shows a further product configuration 1 which here consists of a product 2 formed by a loudspeaker and of a fastening means 3 connected to the product 2 for fastening the product to a product carrier, which is again not shown.

The fastening means 3 is of annular shape in this case, but for the rest has a construction analogous to that of the fastening means 3 of the product configuration 1 of FIG. 1. The fastening means 3 accordingly comprises also in this case a mounting disc 4, of annular shape here, and a first adhesive layer 7 and a second adhesive layer 8 which are both annular in shape. Furthermore, a protective foil 9 is again provided here, also annular in shape. A strip-shaped extension 10 projects from the annular protective foil 9, forming the protective foil removal means 10. In this case, the strip-shaped extension 10 has two projections 13 and 14 in the region of its free end 11, which projections extend transversely to the longitudinal strip direction away from the strip-shaped extension 10 and which projections are provided and constructed so as to grip behind a component of a protective holder.

In practice, a large number of such product configurations 1 as shown in FIG. 2 are automatically manufactured at the manufacturer of these product configurations 1. To render possible a protected transport of the manufactured product configurations 1 to a customer, who incorporates the manufactured product configurations 1 in a product manufactured by him, the manufactured product configurations 1 are inserted into protective holders, whereby a protected transport is safeguarded. Many such manufactured product configurations 1 may be inserted into such a protective holder. The construction of such a protective holder will be discussed in more detail below.

FIG. 3 shows only a portion 16, designed for accommodating one product configuration 1, of a protective holder 15 in which many such product configurations 1 as shown in FIG. 2 can be accommodated. The protective holder 15, and accordingly the portion 16 of the protective holder 15, is made of synthetic resin. It may alternatively be made of paper.

A cradle-type depression 17 is provided in the portion 16 of the protective holder 15. The cradle-type depression 17 is bounded by a plurality of side walls, of which the side walls 18, 19, 20, 21, 22, and 23 are visible in FIG. 3. The cradle-type depression 17 is further bounded by a bottom wall 24. A product configuration 1 as shown in FIG. 2 can be inserted into the cradle-type depression 17, i.e. in a certain position as shown in FIG. 4.

A passage 25 is provided in the bottom wall 24. The passage 25 is provided such that the strip-shaped extension 10 of the protective foil 9 of the product configuration 1 of FIG. 2 can be moved through it. The bottom wall 24 is designed for making mechanical contact with the strip-shaped extension 10 of the protective foil 9 in that the two projections 13 and 14 of the strip-shaped extension 10 grip behind said bottom wall 24, as is apparent from FIGS. 5 and 6.

The cooperation between the product configuration 1 of FIG. 2 and the portion 16 of the protective holder 15 of FIG. 3 will now be briefly described.

After the manufacture of the product configuration 1 of FIG. 2 has been completed, this product configuration 1 is inserted by an automatically operating insertion device into the cradle-type depression 17 of the portion 16 of the protective holder 15, during which an operating stud presses the free end 11 of the strip-shaped extension 10 through the passage 25, as indicated with an arrow in FIG. 4. This has the result that the two projections 13 and 14 of the strip-shaped extension 10 grip behind the bottom wall 24, as is visible in FIG. 5.

Subsequently, the protective holder 15 complete with all product configurations 1 accommodated therein is transported to the manufacturer of appliances, where one product configuration 1 as shown in FIG. 2 is incorporated in each appliance. During the assembly of the product configuration 1 of FIG. 2 with an appliance under manufacture, this product configuration 1 is taken from the protective holder 15 by an automatic removal device, as indicated with an arrow in FIG. 6. During removal of the product configuration 1 from the protective holder 15, the product configuration 1 is gripped by the removal device and taken from the cradle-type depression 17 in the direction of the respective arrows shown in FIGS. 6 and 7, during which the protective foil 9 is retained against the bottom wall 14 of the cradle-type depression 17 by means of the projections 13 and 14 of the strip-shaped extension 10, such that the strip-shaped extension 10 together with the annular protective foil 9 remains in the cradle-type depression, and only the product configuration 1 is taken from the cradle-type depression 17 of the portion 16 of the protective holder 15, as is apparent from FIGS. 6 and 7. The protective foil 9 is detached thereby from the second adhesive layer 8 of the product configuration 1 held by the automatic removal device, so that the product configuration 1 is transported by the removal device towards the envisaged product carrier and can be connected to this product carrier in that an adhesive joint is realized by means of the second adhesive layer 8.

As is apparent from the above description, it is achieved in a particularly simple manner by the use of the product configuration 1 of FIG. 2 and the protective holder 15 of FIG. 3 that the protective foil 9 of the second adhesive layer 8 can be removed from the second adhesive layer 8 without additional expenditure and without the risk of damage to the second adhesive layer 8, which is advantageous for achieving a manipulation of the product configuration 1 which is as inexpensive as possible and also as simple and fast as possible during processing and incorporating of the product configuration 1 into a respective appliance.

The invention is not limited to the embodiments described above. In an alternative embodiment of a product configuration 1 according to the invention, the two adhesive layers 7 and 8 may lie in planes which enclose an angle with one another, for example a right angle. Instead of providing an adhesive layer for retaining a product in contact with a fastening means, the fastening means may alternatively be connected to the relevant product by means of pressure-type snap connections or interlocking connections or soldered connections.

1. A product configuration (1) consisting of a product (2) and a fastening means (3) connected to the product (2) for fastening the product (2) to a product carrier,
wherein the fastening means (3) comprises an adhesive layer (8) provided for connection to the product carrier, and
wherein the adhesive layer (8) is covered by a protective foil (9) that can be removed from the adhesive layer (8), and
wherein the protective foil (9) is provided with a protective foil removal means (10), and
wherein the protective foil removal means (10) is designed for being mechanically connected to a protective holder (15) for the product configuration (1) such that upon a removal of the product configuration (1) from the protective holder (15) an automatic removal of the protective foil (9) from the adhesive layer (8) by the protective holder (15) is ensured.

2. A product configuration (1) as claimed in claim 1, wherein a lateral, strip-shaped extension (10) is connected to the protective foil (8), which extension (10) forms the protective foil removal means (10) and whose free end (11) is designed for making contact with a component (24) of the protective holder (15).

3. A product configuration (1) as claimed in claim 2, wherein the strip-shaped extension (10) has at least one projection (13, 14) extending transversely to the longitudinal strip direction away from the strip-shaped extension (10) in the region of its free end, which projection is provided and shaped so as to grip behind a component (24) of the protective holder (15).

4. A product configuration (1) as claimed in claim 1, wherein the fastening means (3) comprises a mounting disc (9).

5. A product configuration (1) as claimed in claim 4, wherein the mounting disc (9) is of annular shape.

6. A product configuration (1) as claimed in claim 1, wherein the product (2) is formed by an electroacoustic transducer (2).

7. A protective holder (15) for a product configuration (1) as claimed in claim 1, wherein the protective holder (15) comprises a component (24) for making mechanical contact with the protective foil removal means (10) of the protective foil (9) of the product configuration (1).
